(19) United States
(12) Patent Application Publication
(10) Pub. No.: US 2007/0017050 A1
(43) Pub. Date: Jan. 25, 2007

(54) Roller-type paintbrush

(76) Inventor: Sander Lye, Taipei (TW)

Correspondence Address: BACON & THOMAS, PLLC, 625 SLATERS LANE, FOURTH FLOOR, ALEXANDRIA, VA, 22314, US

(21) Appl. No.: 11/183,801

(22) Filed: Jul. 19, 2005

(51) Int. Cl. B05C 17/02

(52) U.S. Cl. 15/230.11; 492/13; 492/19

(57) ABSTRACT

A paintbrush includes a fork and a roller. The fork, which is a Y-shaped member and is made of plastic, has main stem and two branches. Each of the branches has a base section extended outwardly from the main stem, a distal section connected to the base section and a connector connected to the distal section. A roller has opposite ends engaged with the connectors for rotation. A normal direction is defined parallel to the main stem. The base sections of the branches has a width and a thickness respectively, wherein the thicknesses of the base sections are substantially perpendicular to the normal direction, and the widths thereof are perpendicular to the thickness, and the widths are greater than the thicknesses. The distal sections of the branches tilted inwards, such that the roller will not disengaged with the connectors while a normal force is exerted on the roller.

### BACKGROUND OF THE INVENTION

1. Field of the Invention

The present invention relates generally to a painting tool, and more particularly to a roller-type paintbrush.

2. Description of the Related Art

FIG. 1 shows a conventional roller-type paintbrush 40 including a fork 42 and a roller 44. The fork 42 is an integral Y-shaped member, which is made of plastic, having a main stem 46 and two branches 48. Each of the branches 48 has a base stem 50 connected to the main stem 46, a distal stem 52 and a connector 54. The distal stems 52 are substantially parallel to the main stem 46, and the connectors 54 are substantially perpendicular to the distal stems 52. The roller 44 has its opposite end engaged with the connectors 54 respectively by exerting the distal stems 52 outwardly, such that the roller 44 is free for rotation.

While a user paints a wall by the conventional paintbrush, he/she has to exert the paintbrush 40 to make the roller 44 against on the wall (not shown). Therefore, the roller 44 is exerted by a normal force F from the wall. The force F transfers to the branches 48 and makes them bent outwardly while it is greater. The bend of the branches 48 increases a distance between the connectors 54 is increased that the roller 44 might be disengaged with the connectors 54. As a result, the user has to use the paintbrush 40 with less strength because the greater strength might separate the roller 44 from the fork 42.

### SUMMARY OF THE INVENTION

The primary objective of the present invention is to provide a roller-type paintbrush, which the roller is still mounted on the paintbrush while the user exert greater strength on the paintbrush.

According to the objective of the present invention, a paintbrush includes a fork and a roller. The fork, which is a Y-shaped member and is made of plastic, has main stem and two branches. Each of the branches has a base section extended outwardly from the main stem, a distal section connected to the base section and a connector connected to the distal section. A roller has opposite ends engaged with the connectors for rotation. A normal direction is defined parallel to the main stem. The base sections of the branches has a width and a thickness respectively, wherein the thicknesses of the base sections are substantially perpendicular to the normal direction, and the widths thereof are perpendicular to the thickness, and the widths are greater than the thicknesses. The distal sections of the branches tilted inwards, such that the roller will not disengaged with the connectors while a normal force is exerted on the roller.

### BRIEF DESCRIPTION OF THE DRAWINGS

FIG. 1 is a front view of the conventional paintbrush;

FIG. 2 is a sectional view of the conventional paintbrush, showing the roller being exerted by a normal force that bend the branches outwardly and disengage the roller with the paintbrush;

FIG. 3 is a front view of a preferred embodiment of the present invention;

FIG. 4 is a sectional view of the preferred embodiment of the present invention;

FIG. 5 is a sectional view of the preferred embodiment of the present invention, showing the optical film being mounted on the rear of the head.

### DETAILED DESCRIPTION OF THE INVENTION

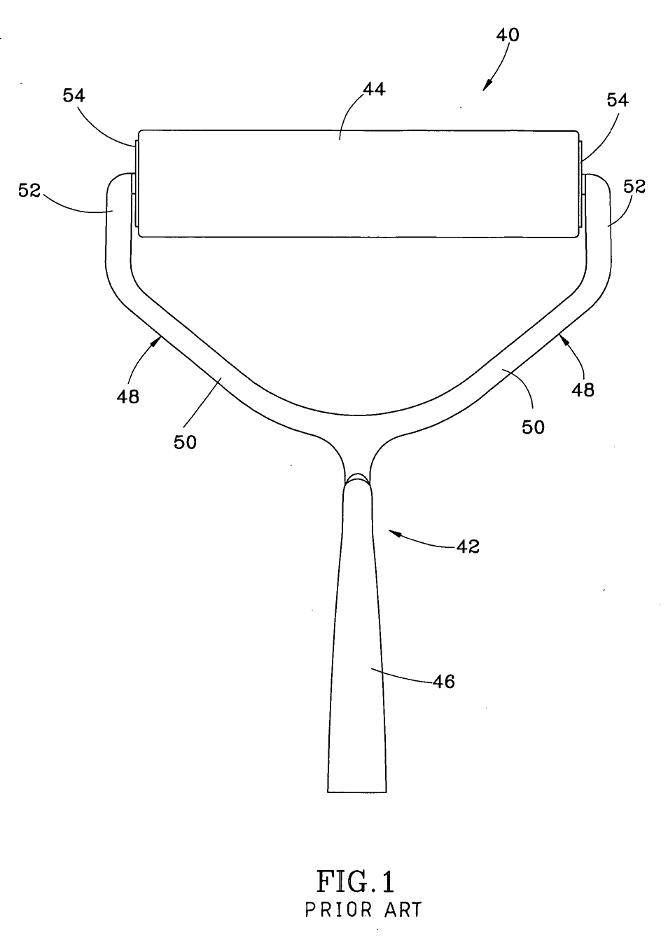

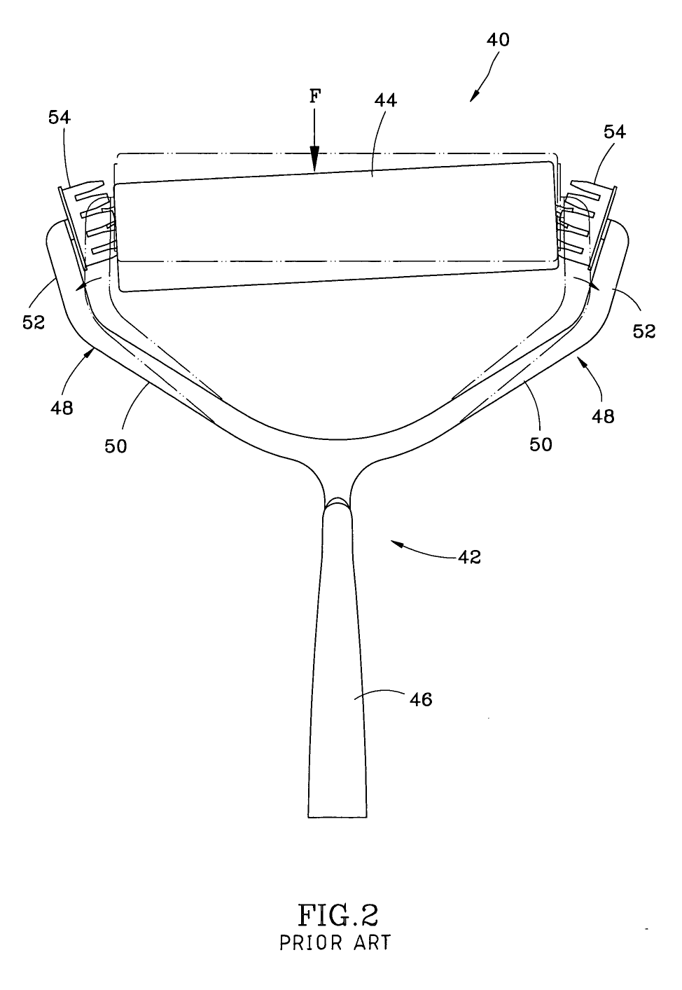

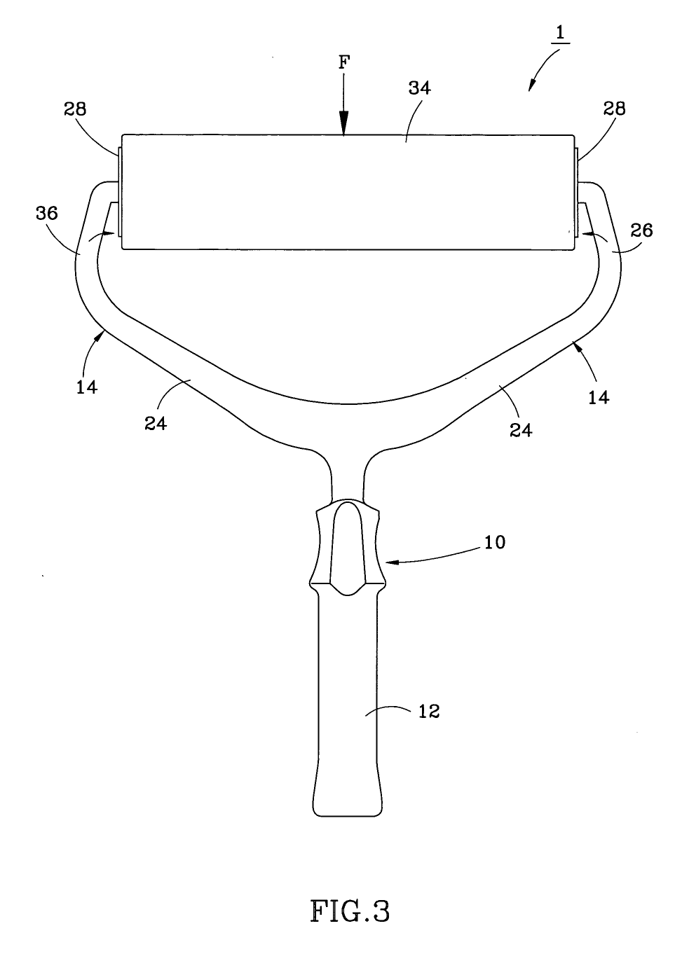

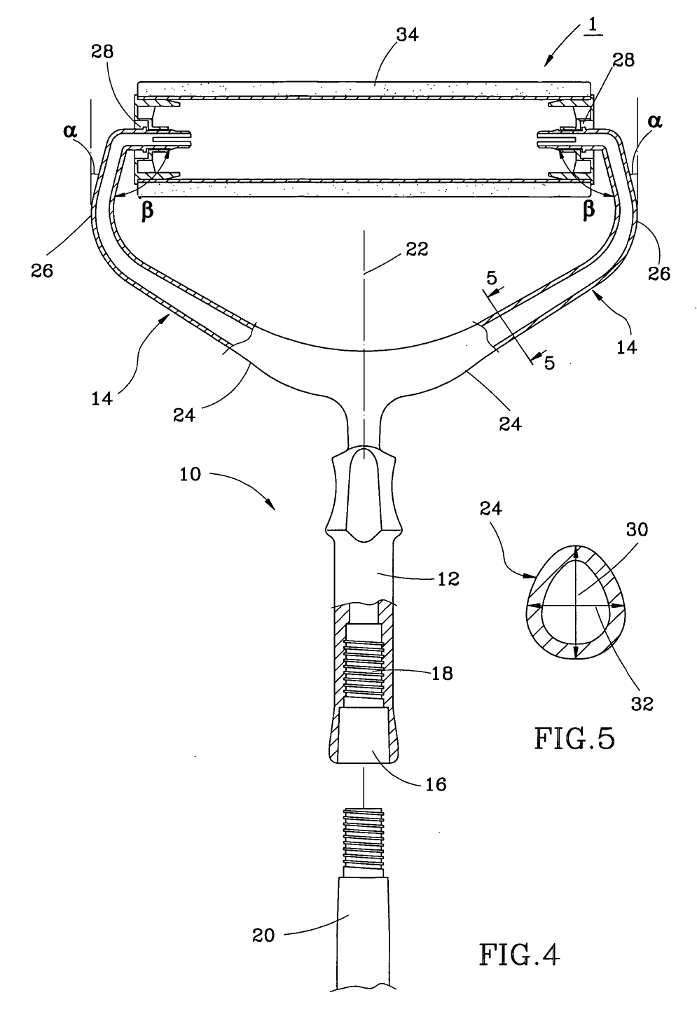

As shown in FIG. 1 and FIG. 2, a roller-type paintbrush 1 of the preferred embodiment of the present invention mainly comprises a fork 10 and a roller 34.

The fork 10 is a Y-shaped, hollow, integral plastic member having a main stem 12 and two branches 14. The main stem 12 has a hole 16 and an inner thread 18 on a sidewall of the hole 16 to be connected to a shaft 20. A normal direction 22 is defined parallel to the main stem 12. Each of the branches 14 has a curved stem defined as a base section 24, a distal section 26 and a connector 28. The base sections 24 of the branches 14 are ellipses in sectional views having a width 30 and a thickness 32 respectively, wherein the thicknesses 32 of the base section 24 are substantially perpendicular to the normal direction 22, and the widths 30 thereof are perpendicular to the base section 24s. A ratio of the widths 30 and the thickness 32 is in a range between 3:2.8 and 3:1, such that the base section 24 of the branches 14 have a greater rigidity along the normal direction 22. The thickness 32 is preferred in a range between 1 cm and 3 cm. The distal sections 26 of the branches 14 are tilted inwards. Angles α between the distal sections 26 and the normal direction 22 are in a range between 1 degree and 50 degrees. The preferred angle α is 12 degrees to 18 degrees. The distal sections 26 are round in sectional views, and they are thinner than the base section 24s, so that the distal sections 26 are more flexible than the base section 24s. The connectors 28 are on ends of the distal sections 26, which is perpendicular to the normal direction 22. The connectors 28 are not perpendicular to the distal sections 26 which angles β therebetween are 91 degrees to 140 degrees. A distance between the connectors 28 is less than a length of the roller 34.

To install the roller 34 on the fork 10, the distal sections 26 of the branches 14 are bent outwardly to increase the distance between the connectors 28 for engagement of the connectors 28 and the roller 34. The mechanism of the connectors 28 and the roller 34 is a well-known structure that one can find it in many inventions. The mechanism of the connectors 28 and the roller 34 is chosen from the US patent application Publication No. 2004/0168276.

While a user paints a wall by the paintbrush 1 of the present invention, a normal force F is exerted on the roller 34 from the wall. The force F transfers to the branches 14 of the fork 10 to bend them. In such situation, the distal sections 26 are bent more than the base sections 24. As a result, the distal sections 26 are bent inwards, which the distance between the connectors 28 is decreased, such that the roller 34 is engaged with the connectors 28 still.

What is claimed is:

1. A paintbrush, comprising:
a fork, which is a Y-shaped member and is made of plastic, having main stem and two branches, wherein each of the branches has a base section extended outwardly from the main stem, a distal section connected to the base section and a connector connected to the distal section, and
a roller having opposite ends engaged with the connectors for rotation;
a normal direction being defined parallel to the main stem;
the base sections of the branches having a width and a thickness respectively, wherein the thicknesses of the base sections are substantially perpendicular to the normal direction, and the widths thereof are perpendicular to the thickness, and the widths are greater than the thicknesses;
the distal sections of the branches tilted inwards for predetermined angles.

2. The paintbrush as defined in claim 1, wherein a ratio of the width and the thickness is in a range between 3:2.8 and 3:1.

3. The paintbrush as defined in claim 1, wherein the thickness is in a range between 1 cm and 3 cm.

4. The paintbrush as defined in claim 1, wherein the base sections of the branches are ellipses in sectional views.

5. The paintbrush as defined in claim 1, wherein the angle between the distal section and the normal direction is preferred in a range between 12 degrees and 18 degrees.

6. The paintbrush as defined in claim 1, wherein the distal sections are thinner than the base sections, such that the distal sections are more flexible than the base sections.

7. The paintbrush as defined in claim 1, wherein an angle between the distal section of the branch and the normal direction is in a range between 1 degree and 50 degrees.
